(19) United States
(12) Patent Application Publication
(10) Pub. No.: US 2005/0252736 A1
(43) Pub. Date: Nov. 17, 2005

(54) Parking brake device and vehicle brake system provided with a parking brake device

(75) Inventors: Ralf Leiter, Vallendar (DE); Ralf Erben, Kemmenau (DE); Gregor Poertzgen, Koblenz (DE)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: Lucas Automotive GmbH

(21) Appl. No.: 11/184,516

(22) Filed: Jul. 19, 2005

Related U.S. Application Data
(63) Continuation of application No. PCT/EP04/00517, filed on Jan. 22, 2004.

(30) Foreign Application Priority Data
Jan. 22, 2003 (DE) 103 02 357.7

(51) Int. Cl. F16D 65/24

(52) U.S. Cl. 188/73.1

(57) ABSTRACT

The invention relates to a parking brake device comprising a spring element and an actuating element that acts upon the spring element, wherein by applying an actuating force to the actuating element the parking brake device is transferrable between a brake-inactive release position and a brake-active parking position. In the invention, it is provided that the spring element is biased in the release position and that the spring element upon transfer from the release position to the parking position yields only upon attainment of an actuating-force threshold value that is determined by the bias.

The present invention relates to a parking brake device comprising a spring element and an actuating element that acts upon the spring element, wherein by applying an actuating force to the actuating element the parking brake device is transferrable between a brake-inactive release position and a brake-active parking position.

Parking brake devices of this type are prior art. They are provided in a vehicle brake system in order to supply not only a braking effect of the brake system triggered by actuation of the brake pedal during operation of the vehicle but also a parking brake effect, e.g. initiated by actuation of a hand brake lever.

Such a parking brake device is known, for example, from DE 197 11 382 C2. The parking brake device is provided on a brake caliper of a vehicle brake system. It comprises an actuating element, which may be set in rotation by means of an electric motor and a worm gear. The actuating element is drive-connected to a threaded sleeve, which in order to achieve a parking brake effect may enter via a spring element into interaction with a brake piston of the vehicle brake system. By rotation of the actuating element, the threaded sleeve may be moved back and forth between the release position and the parking position. In the release position there is no interaction between the threaded sleeve and the brake piston. Upon transfer from the release position to the parking position, the threaded sleeve moves towards the spring element, comes into contact therewith and presses it onto the brake piston of the vehicle brake system, which brake piston in order to achieve a parking brake effect then presses a brake lining onto a brake disc. In so doing, the spring element is compressed. Given a cooling-related shrinkage of brake linings and brake disc, the spring element may then expand once more and ensure a sufficiently good parking brake effect despite the shrinkage of brake linings and brake disc.

The parking brake device according to DE 197 11 382 C2 does however have the drawback that a relatively long infeed travel of the threaded sleeve is needed to achieve a transfer from the release position to the parking position. The reason for this is that in the release position no interaction between threaded sleeve and brake piston is desired and so the threaded sleeve has to be moved a corresponding distance away from the spring element. A further reason for the long infeed travel is that the threaded sleeve during transfer from the release position to the parking position acts upon the fully relaxed spring element and has to compress the spring element over a relatively large section in order to exert a high enough force on the brake piston to achieve the desired parking brake effect also after cooling-related shrinkage of brake linings and brake disc. Furthermore, with increasing compression of the spring element in accordance with the force-displacement characteristic thereof the actuating force to be summoned up rises continuously, with the result that the electric motor has to be of a powerful design in order to be able to guarantee a sufficiently large infeed travel.

Against this background, an object of the present invention is to provide a parking brake device of the initially described type, which with reduced actuating force and less infeed travel guarantees a reliable parking brake effect in particular also after cooling-related shrinkage of brake linings and brake disc.

This object is achieved by a parking brake device comprising a spring element and an actuating element that acts upon the spring element, wherein by applying an actuating force to the actuating element the parking brake device is transferrable between a brake-inactive release position and a brake-active parking position, wherein moreover the spring element is biased in the release position and wherein the spring element upon transfer from the release position to the parking position yields perceptibly only upon attainment of an actuating-force threshold value that is determined by the bias.

The invention provides that the spring element is under bias already in the release position. So, when upon transfer from the release position to the parking position the actuating element acts upon the biased spring element, this spring element therefore behaves initially like a rigid element, i.e. it does not yield or yields only slightly. The infeed motion is therefore transmitted directly to the brake piston and from there to the brake linings. It is only upon attainment of the actuating-force threshold value, which is predetermined e.g. by the degree of bias, that the spring element yields and is consequently compressed. This leads to a kink in the force-displacement characteristic curve of the entire arrangement. The actuating force needed for a further infeed motion no longer increases to the same extent as before in the case of rigid or approximately rigid behaviour of the spring element.

The actuating-force threshold value is advantageously so selected that immediately before attainment thereof a force high enough for a desired parking brake effect is exerted on the brake piston and by the brake piston on the brake lining. If the actuating-force threshold value is then attained, then substantially only the spring element is compressed, this however owing to the force-displacement characteristic curve of the spring element being effected with a lower expenditure of force per infeed distance than immediately before attainment of the actuating-force threshold value. This compression of the spring element may be then utilized later, e.g. in the event of cooling-related shrinkage of various components of the vehicle brake system, such as brake linings and brake disc, to compensate the shrinkage in that the spring element expands again.

If the actuating force is summoned up by an electric motor, for example in the case of an electromotive parking brake, then by virtue of the invention it is possible to use a less powerful and hence less expensive electric motor than is the case, for example, with the initially described background art.

In order to be able to achieve the previously discussed behaviour of the spring element by simple constructional measures, in a development of the invention it is provided that the spring element is enclosed under bias in a spring chamber, wherein at one end of the spring element a pressure plate is disposed, which is displaceable in the spring chamber with simultaneous deformation of the spring element. In said case, the actuating element presses upon the pressure plate. The pressure plate, however, yields markedly with simultaneous compression of the spring element only upon attainment of the actuating-force threshold value, i.e. the precise actuating force value at which the spring element, starting from its actual biased state, is compressible further.

In this connection, according to the invention it may further be provided that the spring chamber is formed in a hollow cylinder. In this variant of the invention, the hollow cylinder may be open at one end, thereby allowing the spring element and the pressure plate to be introduced through the opening. Furthermore, for this variant of the invention it may be provided that the movement of the pressure plate or/and of the actuating element inside the spring chamber is restricted at one end. Such a restriction may be realized according to the invention by means of a locking ring fixed in the hollow cylinder.

In principle, when selecting the spring element there is a wide range of options, which each entail different constructional developments. Thus, according to the invention the spring element may take the form of a compression spring or a tension spring. What is more, the spring element may be formed by a spiral spring or alternatively comprise an elastomer body. Equally conceivable, however, is the use of a cup-spring assembly or a spring arrangement comprising a plurality of spring components, such as e.g. springs connected in parallel or in series.

It was explained above that, upon activation of the parking brake device, the pressure plate interacts with the actuating element. This presupposes that pressure plate and actuating element are formed separately from one another. To simplify the arrangement according to the invention further, in a development of the invention it is provided that the pressure plate and the actuating element are of an integral construction. Thus, the pressure plate may for example be stamped out as an end flange on the actuating element that is disposed in the spring chamber.

According to the invention, in one form of construction the parking brake device may be provided directly on a brake caliper of a vehicle hydraulic brake system. In the framework of this form of construction, according to the invention it is further possible for the hollow cylinder to be formed by a brake piston of the vehicle brake system or by a spring bush accommodated in the brake piston. In this development of the invention, the actuating force is transmitted directly to the brake piston of the brake system and from there via the brake lining to the brake disc of a wheel that is to be immobilized.

As an alternative thereto, it is also possible that the actuating element comprises a control cable acting on the pressure plate and that a further control cable is provided on the hollow cylinder. One of the control cables is then connected to the actuating member of the parking brake device, e.g. to the hand brake lever. The other control cable interacts with the brake piston of the brake system.

The invention further relates to a vehicle brake system, in particular a vehicle hydraulic brake system, comprising a brake piston, which is provided on a brake caliper and guided displaceably in a pressure chamber in order to displace a brake lining in the direction of a brake disc, wherein the vehicle brake system is provided with a parking brake device of the previously described type.

The invention is described below by way of example with reference to the accompanying drawings. The drawings show:

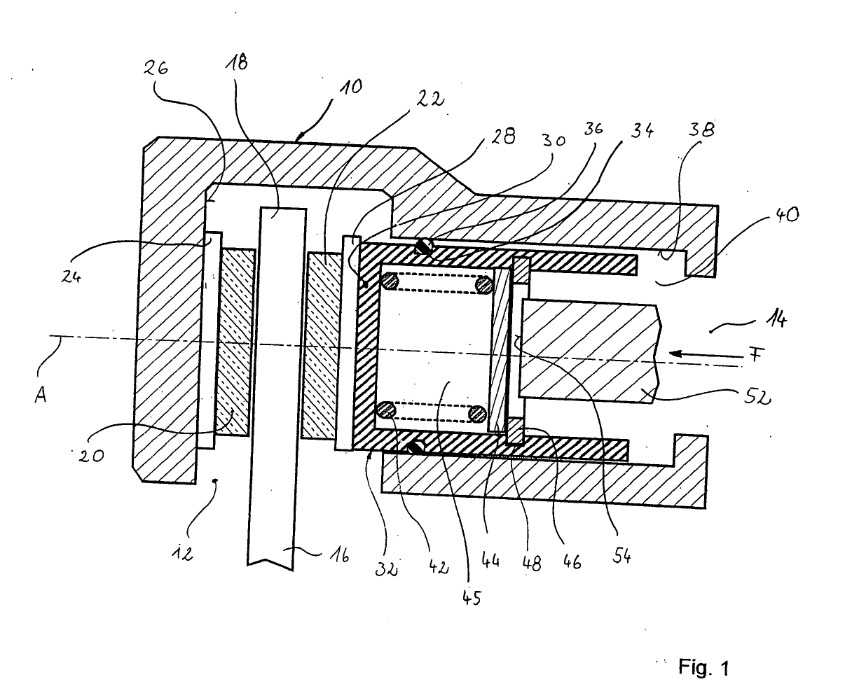

FIG. 1 a sectional view of a first embodiment of the area close to the brake caliper of a vehicle brake system according to the invention;

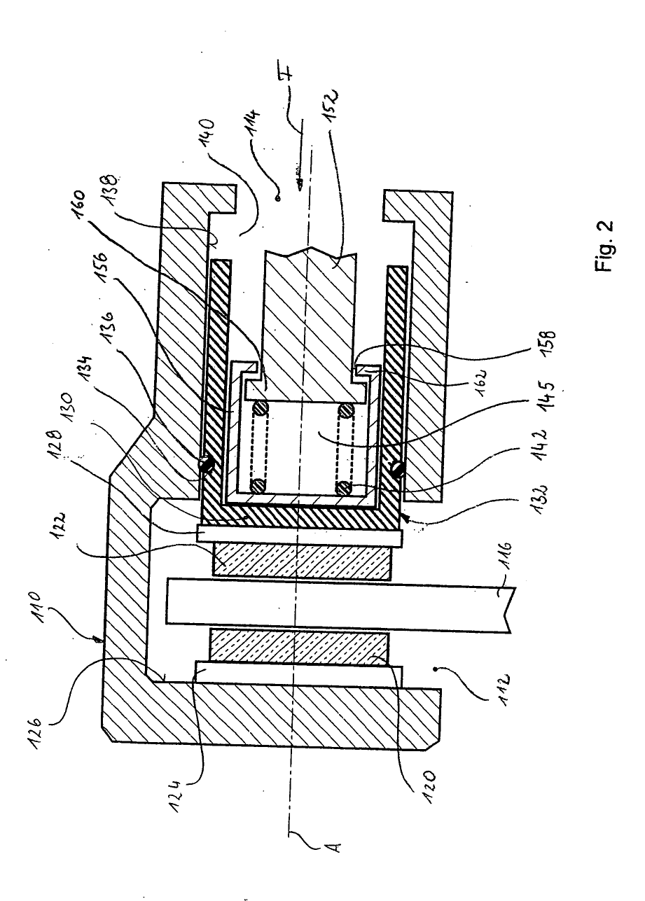

FIG. 2 a view corresponding to FIG. 1 of a second embodiment according to the invention;

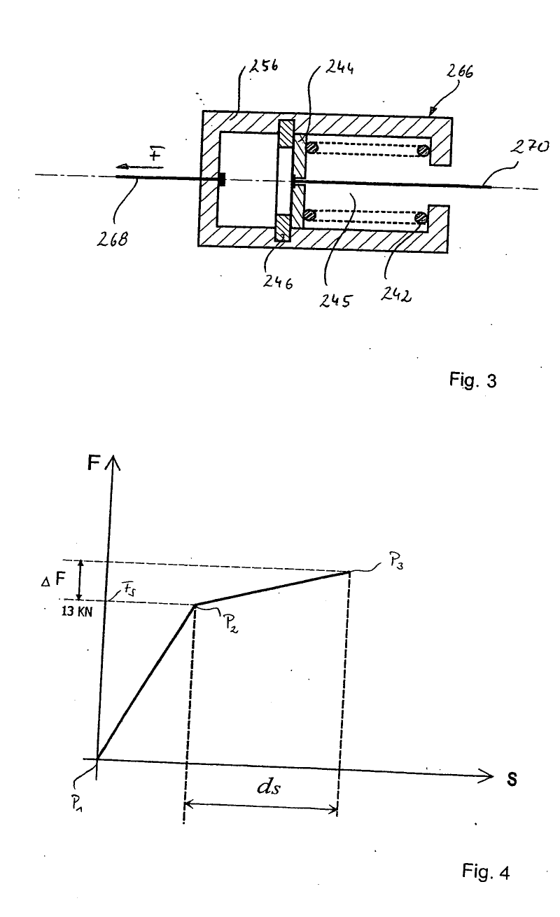

FIG. 3 a sectional view of part of a vehicle brake system according to the invention provided with a control cable and

FIG. 4 a force-displacement characteristic curve of the parking brake device according to the invention.

FIG. 1 shows a part-sectional view of the area close to the brake caliper of a vehicle brake system according to the invention with a parking device in its release position. In particular, FIG. 1 shows a housing 10 with an opening 12 and an opening 14. Projecting into the opening 12 is an only partially illustrated brake disc 16, which is connected to a vehicle wheel that is to be braked and/or immobilized. Brake linings 20 and 22 are disposed on the left and right respectively of a radial end region 18 of the brake disc 16. The brake lining 20 is attached by a stabilizing back plate 24 to the inside 26 of the housing 10. The brake lining 22 is attached by a further stabilizing back plate 28 to the end face 30 of a brake piston 32, which is guided in the housing 10 displaceably along an axis A.

The housing 10 is float-mounted relative to the brake disc 16. It is therefore possible that, upon an infeed motion of the brake lining 22 towards the brake disc 16 and a frictional action of the brake lining 22 upon the brake disc 16, the housing 10 shifts in FIG. 1 to the right so that the brake lining 20 also moves into abutment with the brake disc 16. The result of this is that the brake disc 16 is clamped with a braking effect in between the brake linings 20 and 22.

The brake piston 32 is of a hollow-cylindrical design and open at one end. In its outer peripheral surface it has a circumferential groove 34, into which a sealing ring 36 is inserted. The sealing ring 36 rests in a fluid-proof manner against an inner peripheral surface 38 of the housing 10. The brake piston 32 is therefore guided in a fluid-proof displaceable manner in the housing 10 and with the housing 10 encloses a hydraulic-fluid pressure chamber 40. By injecting hydraulic fluid into the pressure chamber 40, the brake piston 32 in a known manner is movable in axial direction in the housing 10. In said case, the brake linings 20 and 22 may press with a frictional effect upon the brake disc 18 and brake the brake disc, in the manner described above. By subsequently removing hydraulic fluid from the hydraulic-fluid pressure chamber 40, this braking effect may be discontinued.

In its interior, the hollow-cylindrical brake piston 32 has a compression spring 42. This spring is supported by one end against the end face 30 of the brake piston 32. With its other end, the compression spring 42 rests against a pressure plate 44, which together with the brake piston 32 delimits a spring chamber 45. The pressure plate 44 is accommodated in an axially displaceable manner in the interior of the brake piston 32. The displacement motion along the axis A is however restricted by means of a locking ring 46, which is fitted in a circumferential groove 48 in an inner peripheral surface 50 of the brake piston 32.

Projecting in axial direction into the hydraulic-fluid pressure chamber 40 is an actuating element 52, which may be moved into the interior of the brake piston 32 by a non-illustrated parking actuating member. The actuating element 52 is dimensioned in such a way that it may pass through the locking ring 46 and act with its end face 54 upon the pressure plate 44.

The compression spring 42 is held by the pressure plate 44 and the locking ring 46 in a partially compressed state, which differs clearly from a fully relaxed state of the spring. The term also used for this is a “restrained spring”. In this partially compressed state, the compression spring 42 in the spring chamber 45 is impossible to compress until the compressive force acting upon it reaches a value corresponding to the instantaneous point in the force-displacement characteristic curve of the compression spring 42. It is only upon attainment of this force threshold value that the compression spring 42 yields and is compressible.

There now follows a description of the mode of operation of the brake system according to the invention with reference to FIGS. 1 and 4. When the parking brake device is activated, e.g. for parking the vehicle, in that the non-illustrated parking actuating member is actuated, the actuating element 52 is displaced by applying an e.g. electromotively generated actuating force F in axial direction towards the pressure plate 44. In FIG. 4 the point, at which the infeed motion begins, is denoted by P₁. As soon as the end face 54 of the actuating element 52 is acting with a sufficiently high actuating force F upon the pressure plate 44, the brake piston 32 shifts in the housing 10 and brings the brake linings 20 and 22 into abutment with the brake disc 18. At the start of this displacement motion of the brake piston 32, the actuating force F is not high enough to compress the compression spring 42 further. The compression spring 42 in this operating phase behaves rather like a rigid element. In order to bring the brake linings 20 and 22 into brake-active abutment with the brake disc 18 and in order to press these against one another with sufficient strength, a continuous increase of the actuating force F is required. The force-displacement characteristic curve according to FIG. 4 rises until it reaches point P₂. At point P₂ the actuating force reaches the threshold value F_{S}, at which the compression spring 42 no longer behaves substantially rigidly but may be compressed further beyond its biased state. The value of the actuating-force threshold value F_{S} is so selected that, upon attainment thereof, the brake linings 20, 22 press upon the brake disc 18 with sufficient strength to guarantee a reliable parking brake effect. If the actuating force F is then increased further, substantially only the compression spring 42 is compressed, i.e. the force-displacement characteristic curve according to FIG. 4 is determined substantially by the behaviour of the compression spring 42. For example, the actuating-force threshold value F_{S} lies in the range of between 10 and 15 kN, being preferably 13 kN.

To achieve a specific infeed travel ds from point P₂ to a hypothetical point P₃, only a relatively slight increase ΔF of the actuating force F is required. The corresponding infeed motion is used substantially to compress the compression spring 42 to such an extent that it may effect a secondary pressing of the brake piston 32 and guarantee a sufficiently strong parking brake effect when the brake linings 20, 22 and the brake disc 18, which heat up during operation of the vehicle, after parking and in the parked state of the vehicle cool down and consequently shrink. The cooling-related shrinkage of the brake linings 20, 22 and the brake disc 18 may then be compensated by expansion of the compression spring 42, wherein the force, with which the brake linings 20 and 22 press upon the brake disc 18, is at least at great as the force threshold value F_{S}.

FIG. 2 shows a second embodiment of the invention. To avoid repetition and for the sake of a simple description, only the differences from the form of construction according to FIG. 1 are to be described. For this, the same reference characters as in the description of FIG. 1 are used, only with the number “1” placed in front.

The form of construction according to FIG. 2 differs from the form of construction according to FIG. 1 substantially in that the spring chamber is formed not directly in the interior of the brake piston 132. Rather, a spring bush 156 is inserted into the interior of the brake piston 132 and rests against the end face 130 thereof. The spring bush 156 is of a hollow design and open at one end. Into its opening 158 the actuating element 152 is introduced. The actuating element 152 on its, in FIG. 2, left end has a flange 160, which acts like the pressure plate 44 of FIG. 1 and is in abutment with the compression spring 142. The spring bush 156 at its opening 158 has a collar 162, which restricts the movement of the actuating element 152.

In operation, the form of construction according to FIG. 2 functions in the manner described above with reference to the form of construction according to FIG. 1 and with reference to FIG. 4. This means that the compression spring 142 initially behaves like a rigid element and yields only after attainment of an actuating-force threshold value F_{S}.

The form of construction according to FIG. 2, compared to that according to FIG. 1, has the advantage of a simplified structural design particularly because of the integral construction of the actuating element 152 and the flange 160 acting as a pressure plate. It is therefore possible to prefabricate the spring bush 156 and the actuating element 152 to form a unit and during assembly insert this unit into the interior of the brake piston 132 without any need for further measures, such as e.g. the fitting of a locking ring.

FIG. 3 shows a part of a further form of construction of a parking brake device according to the invention. This form of construction is used in the case of a parking brake device that is actuable by control cable. For the description of this form of construction, once again the previously used reference characters are used, only with the number “2” placed in front.

In this form of construction a spring assembly 266 is provided, which is disposed between two control cables 268 and 270. The control cable 268 is fastened at one end to a spring bush 256 and at its end not shown in FIG. 3 is connected to the actuating member of the parking brake device. The control cable 270 is fastened at one end to the pressure plate 244 and at its end not shown in FIG. 4 is connected to the brake piston of the vehicle brake system. The spring bush, in a manner similar to that shown in FIG. 2, encompasses a compression spring 242, which is biased by means of a pressure plate 246 and a locking ring 246.

Upon actuation of the actuating member of the parking brake device, the compression spring 242 because of its bias initially acts like a rigid element and transmits the actuating force F, which is introduced via the control cable 268, without deformation to the control cable 270. However, as soon as the actuating force reaches and exceeds the actuating-force threshold value F_{S}, the compression spring 242 yields and is compressed without the control cable 270 being simultaneously moved in a corresponding manner. The compression spring 242 therefore stores some of the actuating force F, so that this force may be released later, where necessary, for a further infeed motion—e.g. caused by a shrinking of brake linings and brake disc—with simultaneous reduction of the compression.

It should be pointed out that it is also possible for a plurality of spring assemblies 266 according to FIG. 3 to be connected in series in order to achieve an adequate spring action.

The invention demonstrates a possible way of realizing, with constructionally simple means, a parking brake device that is operable with a relatively low actuating force and yet guarantees a reliable parking brake effect. This applies above all when, during parking of the vehicle after a journey, due to cooling, the brake linings and brake disc of the vehicle brake system contract.

1. Parking brake device comprising:
a spring element; and
an actuating element that acts upon the spring element,
wherein by applying an actuating force to the actuating element the parking brake device is transferrable between a brake-inactive release position and a brake-active parking position,
wherein the spring element is biased in the release position and that the spring element upon transfer from the release position to the parking position yields perceptibly only upon attainment of an actuating-force threshold value that is determined by the bias.

2. Parking brake device according to claim 1,
wherein the spring element is enclosed under bias in a spring chamber, wherein at one end of the spring element a pressure plate is disposed, which is displaceable in the spring chamber with simultaneous deformation of the spring element.

3. Parking brake device according to claim 2,
wherein the spring chamber is formed in a hollow cylinder.

4. Parking brake device according to claim 2,
wherein the movement of the pressure plate or/and of the actuating element inside the spring chamber is restricted at one end.

5. Parking brake device according to claim 4,
wherein the restriction is provided by means of a locking ring fixed in the hollow cylinder.

6. Parking braking device according to claim 1,
wherein the spring element comprises a compression spring, a tension spring, a spiral spring and/or an elastomer body.

7. Parking braking device according to claim 2,
wherein the pressure plate and the actuating element are of an integral construction.

8. Parking brake device according to claim 1,
wherein the parking brake device is provided on a brake caliper of a vehicle hydraulic brake system.

9. Parking brake device according to claim 8,
wherein the hollow cylinder is formed by a brake piston of the vehicle brake system or by a spring bush accommodated in the brake piston.

10. Parking brake device according to claim 3,
wherein the actuating element is a control cable acting upon the pressure plate and that a further control cable is provided on the hollow cylinder.

11. (canceled)

12. A vehicle brake system comprising:
a brake piston, which is provided on a brake caliper and which for displacement of a brake lining towards a brake disc is guided displaceably in a pressure chamber; and
a parking brake device including a spring element and an actuating element that acts upon the spring element, wherein by applying an actuating force to the actuating element the parking brake device is transferrable between a brake-inactive release position and a brake-active parking position;
wherein the spring element is biased in the release position and that the spring element upon transfer from the release position to the parking position yields perceptibly only upon attainment of an actuating-force threshold value that is determined by the bias.
